(19) United States
(12) Patent Application Publication
(10) Pub. No.: US 2010/0132873 A1
(43) Pub. Date: Jun. 3, 2010

(54) MONITORING APPARATUS AND METHOD FOR MONITORING A JOINING PROCESS AND FOR RETRACING QUALITY

(75) Inventor: Ulrich Lang, Marktoberdorf (DE)

Correspondence Address: SHERIDAN ROSS PC, 1560 BROADWAY, SUITE 1200, DENVER, CO, 80202, US

(73) Assignee: ASSA ABLOY IDENTIFICATION TECHNOLOGIES GMBH, Walluf (DE)

(21) Appl. No.: 12/067,703

(22) PCT Filed: Sep. 14, 2006
(86) PCT No.: PCT/EP2006/066386

§ 371 Date: Oct. 5, 2009

(30) Foreign Application Priority Data
Sep. 23, 2005 (DE) 10 2005 045 766.5
Dec. 22, 2005 (DE) 10 2005 062 014.0

(51) Int. Cl. B29C 65/00; B23K 37/00

(52) U.S. Cl. 156/64; 156/378; 228/56.5; 228/105

(57) ABSTRACT

Disclosed are an apparatus for monitoring a process of joining components and for retracing quality, at least sections of an image which has been recorded by a camera and has been reproduced by a screen being able to be stored together with an identity number in a memory device, and a method for using such an apparatus.

The invention relates to a monitoring apparatus for monitoring a joining process according to the precharacterizing clause of Claim 1 and to a method for using such a monitoring apparatus.

In order to reduce rejects in the case of products comprising a large number of individual components, it is necessary for the components to be joined with a high level of quality. In order to safeguard the joining quality, various apparatuses and methods for monitoring the joining processes are known. For example, when producing a transponder unit, a process of welding a wire to corresponding contact areas of a chip module, which holds a chip, is thus monitored using a camera which reproduces the welding process on a screen which is viewed by an employee so that he can assess the welding process and can sort out transponder units having inferior welded connections. The disadvantage of this method is that, after the transponder unit has been completed, the welding processes which are observed by the employee can no longer be assigned to the respective transponder unit. It is also disadvantageous that, in particular after encapsulation, i.e. after the chip module has been covered with a covering layer, for example when the transponder unit is used for electronic passes or for contactless bank cards, the welded connections are no longer visible and the quality of the welded connections therefore cannot be retraced.

It is an object of the present invention to provide a monitoring apparatus for monitoring a joining process and for retracing quality, said apparatus allowing a reliable and subsequent report on the nature of a joint, and to provide a method for using such a monitoring apparatus.

This object is achieved by means of a monitoring apparatus having the features according to Claim 1 and by means of a method according to Claim 4.

A monitoring apparatus for monitoring a process of joining components according to the invention has a camera for recording the joining process and a screen for reproducing the joining process. According to the invention, there is provided a read device for detecting an identity number and a memory device for storing the identity number and at least one section or part of the reproduction of the joining process in pairs. The solution according to the invention has the advantage that the joining processes can be assigned to the individual components at any time, with the result that, even after the joint has been completed, it is possible to give a reliable report on the quality of said joint.

In one preferred embodiment, the read device has an inductive reader for inductively reading the identity number.

In another embodiment, the read device has a scanner for optically detecting the identity number.

A method for monitoring a process of joining components according to the invention provides for the use of the monitoring apparatus according to the invention. In this case, according to the invention, the joining process is recorded in a first working step and is reproduced on a screen. In a second working step, i.e. after the joint has been completed, the identity number is detected and is assigned to the reproduction in a third working step. In a fourth working step, at least sections of the reproduction and the identity number are stored in pairs. However, the first working step may also follow the second working step, with the result that the identity number is detected first and the joining process is then recorded and reproduced.

The reproduction may be provided with a raster for the improved detection of faults in the joining process.

In one preferred variant of the method, in addition to storing the reproduction and the identity number, joining parameters and/or production data may be stored and assigned to the respective identity number. The individual joining parameters are preferably compared with their desired values during the joining process and are manually or automatically reset when a maximum tolerance is exceeded.

The method according to the invention may be used, for example, to produce a transponder unit, in which contact-connection of a wire to corresponding contact areas of a chip module, which holds a chip, is monitored. In this case, the identity number of the chip is preferably detected. However, it is also conceivable for the wire to be contact-connected directly to pads of the chip, i.e. without the use of a chip module.

Further subclaims relate to other advantageous embodiments of the invention.

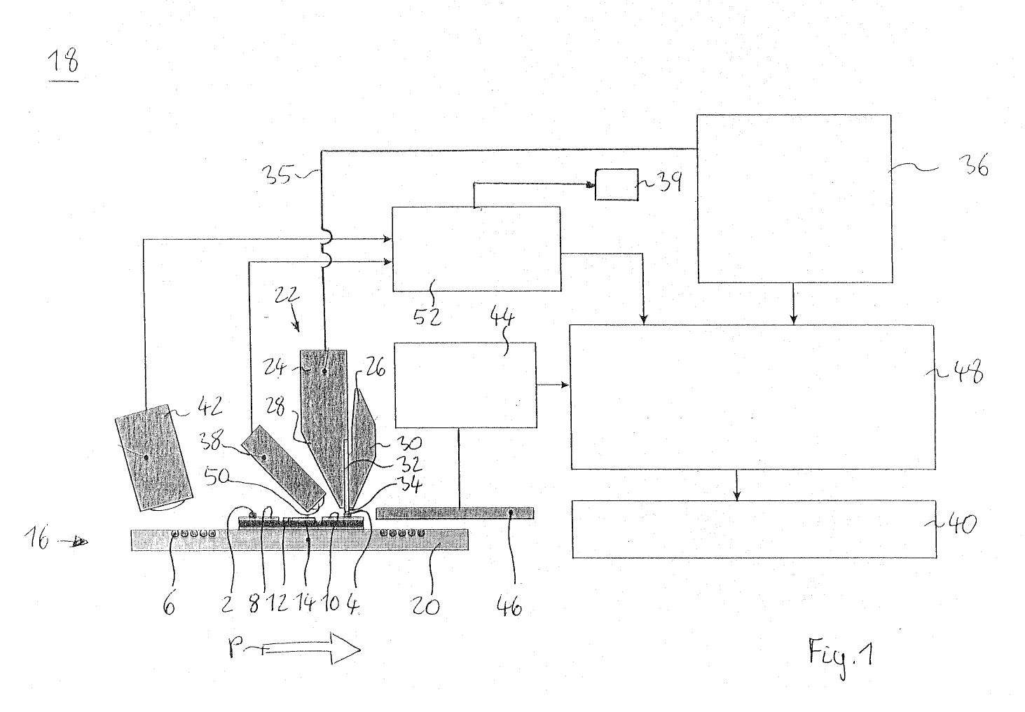

Preferred embodiments of the invention will be explained in more detail below with reference to a diagrammatic illustration. The single FIG. 1 shows inventive monitoring of a welding process for producing a transponder unit.

The single FIG. 1 illustrates, by way of example, the use of an inventive monitoring apparatus 18 to monitor a process of contact-connecting end sections 2, 4 of a wire 6 to contact areas 8, 10 of a chip module 14, which holds a chip 12, for the purpose of producing a transponder unit 16.

The transponder unit 16 is used, for example, for electronic passes or for contactless bank cards. It has a flat substrate 20 in which the wire 6 is embedded in the manner of a coil and on which the chip module 14 is arranged. The wire 6 acts as an antenna for the chip 12 which has an identity number and is connected to the contact areas 8, 10.

The arrangement of the chip 12 on the chip module 14 has the advantage that pads (not illustrated) of the chip 12 are enlarged using the contact areas 8, 10 of the chip module 14 and contact-connection to the end sections 2, 4 is thus simplified. However, it is also conceivable for the end sections 2, 4 of the wire 6 to be contact-connected directly to the pads of the chip 12.

The wire 6 is embedded in the substrate 20 using a laying apparatus (not illustrated) by means of the application of ultrasound. The end sections 2, 4 are contact-connected to the contact areas 8, 10 using a contact-connection apparatus 22. The laying apparatus and the contact-connection apparatus 22 essentially correspond to the laying apparatus and contact-connection apparatus described in the applicant's application DE 10 2005 028 467.1, with the result that reference is expressly made to said application as regards the detailed design of the laying apparatus and the contact-connection apparatus 22 and only a simplified description of the contact-connection apparatus 22 will be given below.

The contact-connection apparatus has two clamping jaws 24, 26, a thermode 32 being arranged between the head sections 28, 30 of said clamping jaws and the tip 34 of said thermode projecting beyond the head sections 28, 30 in the longitudinal direction.

In order to contact-connect the wire 6 to the contact areas 8, 10, preferably by means of thermocompression welding, the contact-connection apparatus 22 is energized by a welding generator 36 via a current line 35, the greatest resistance existing in the region of the thermode tip 34, thus heating the latter. When the thermode tip 34 is pressed down onto the respective end section 2, 4, the latter is heated, the end sections 2, 4, inter alia, being freed of their insulation, being deformed and being connected to the respective contact area 8, 10.

The monitoring apparatus 18 for monitoring the welding process has a camera 38 for recording the welding process and a screen 39 for reproducing the welding process for an employee. The lens 50 of the camera 38 is aimed directly at the respective contact area 8, 10 and thus at the welding process.

Furthermore, the monitoring apparatus 18 has, as a read device for detecting the identity number of the chip 12, an inductive reader 44 having a read antenna 46 for inductively reading the identity number. The reader 44 is a reader which is known per se for contactless data traffic, in particular in active and passive transponder units which are operated at low, high and ultrahigh frequency.

The reader 44 is arranged behind the contact-connection apparatus 22 in the direction of production (see arrow P in FIG. 1). In this case, a voltage is induced in the wire 6, which has been laid on the substrate 20 and has been connected to the chip 12, in order to read the identity number from the chip 12, and the identity number is read using the read antenna 46.

The monitoring apparatus 18 also has a memory device 48 which is in the form of a database and is intended to store the reproduction of the welding process and the identity number. According to the invention, the reproduction and the identity number are stored in pairs in the memory device 48, it also being possible to store only individual photographic representations or sequences of the welding process.

In addition, welding parameters, for example the current intensity and the resistance in the region of the thermode tip 34, may be stored in the memory device 48 and assigned to the respective identity number.

Operating parameters of the laying apparatus, for example information regarding the application of ultrasound, may likewise be stored in the memory device 48.

Production data, for example batch number, date, wire diameter, may likewise be stored in the memory device 48 with reference to the identity number.

The recording and reproduction of the welding process may be appropriately processed using software 52. The software 52 allows, for example, digitization and rasterization of the reproduction as well as the display of the welding process on the screen 39 on different levels and in different partial views.

The software 52 also makes it possible to assess the deformation of the respective end section 2, 4, which occurs during contact-connection. To this end, the software 52 compares the actual deformation with stored desired deformations, which were determined, for example, using experiments, and automatically intervenes, in regulating fashion, for example, in a control system of the welding generator 36 when a maximum tolerance limit is exceeded in order to correct the relevant welding parameters, for example the current intensity applied to the contact-connection apparatus 22, in order to change the resistance at the thermode tip 34. However, the software 52 can also arrange for a message for the employee to be created so that the latter manually resets the respective welding parameters.

The software 52 likewise allows the diameter of the wire 6 to be measured, in which case said software can intervene, in regulating fashion, as described above, in the control unit of the welding generator 36 on the basis of the diameter measured.

Provision is also made for a quality record 40 to be output, the identity number, at least parts of the reproduction of the welding process, the abovementioned exemplary welding parameters and production data being able to be individually compiled in said record depending on the employee's settings.

When using the reader 44, the process of welding the respective end section 2, 4 to the respective contact areas 8, 10 is recorded and reproduced on the screen 39 in a first step, so that the employee can assess each welded connection and can sort out transponder units 16 having faulty welded connections. In a second step, i.e. after the welded connections have been completed, the identity number is inductively read from the chip and, in a third step, the identity number is assigned to the reproduction of the joining process. In a fourth step, the reproduction and the identity number are stored in pairs in the memory device 48. In a fifth step, the chip module 14 is encapsulated with a covering layer, so that the chip 12 and the welded connections can no longer be seen from the outside. In a sixth step, the quality record 40 is output and is enclosed with the transponder unit 16 as a manufacturer's certificate so that the quality of each welded connection can be retraced.

The ability to retrace the quality is particularly important when, for example, an electronic pass having such a transponder unit 16 is faulty and the cause of the fault needs to be determined; whether, for example, a faulty welded connection or a break in the wire 6 is the cause of the fault, with the result that the wire 6 no longer acts as an antenna, or whether a break in the chip 12 has caused the fault.

The inventive monitoring apparatus 18 and the inventive method are not restricted to monitoring and retracing the quality in welding processes for producing a transponder unit 16 but rather may be used, in principle, in all joining processes.

It is thus conceivable, for example, to generally monitor a diffusion welding process in which components are joined under temperature and pressure using a tungsten or diamond welding tool, for example. It is likewise conceivable to monitor an ultrasonic welding process in which, for example, the laying apparatus or sonotrode described in the abovementioned application DE 10/2005/028/467.1 is used, a laser welding process, a soldering process or a conductive adhesive joining process.

In situations in which at least one of the components to be joined does not have an internally stored identity number like the chip 12 but rather has an identity number which is applied, for example, as a barcode to the outside of the component such that it is visible, the monitoring apparatus 18 has, instead of the inductive reader 44, a scanner 42 for optically detecting the visible identity number. According to the illustration in FIG. 1, the scanner 42 is arranged in front of the contact-connection apparatus 22 in the direction of production. In contrast to the use of the inductive reader 44, when using the scanner 42, the identity number of the component is accordingly read by the scanner 42 in a first step and the welding process is recorded using the camera 38 and reproduced on the screen 39 only in a second step. The remaining steps and the order thereof are identical to the above-described steps 3 to 6 when using the inductive reader 44.

Disclosed are an apparatus for monitoring a process of joining components and for retracing quality, at least sections of an image which has been recorded by a camera and has been reproduced by a screen being able to be stored together with an identity number in a memory device, and a method for using such an apparatus.

### LIST OF REFERENCE SYMBOLS

2 End section

4 End section

6 Wire

8 Contact area

10 Contact area

12 Chip

14 Chip module

16 Transponder unit

18 Monitoring apparatus

20 Substrate

22 Contact-connection apparatus

24 Clamping jaw

26 Clamping jaw

28 Head section

30 Head section

32 Thermode

34 Thermode tip

35 Current line

36 Welding generator

38 Camera

39 Screen

40 Quality record

42 Scanner

44 Reader

46 Read antenna

48 Memory device

50 Lens

52 Software

1. Monitoring apparatus for monitoring a process of joining components, said apparatus comprising:
a camera for recording the joining process and having a screen for reproducing the joining process;
a read device adapted for detecting an identity number; and
a memory device adapted for storing at least one section of the reproduction of the joining process with the identity number in pairs.

2. Monitoring apparatus according to claim 1, wherein the read device has a scanner for optically detecting the identity number.

3. Monitoring apparatus according to claim 1, wherein the read device has an inductive reader for inductively reading the identity number.

4. Method for monitoring a process of joining components, comprising:
a) recording the joining process using a camera and reproducing the joining process on a screen;
b) detecting an identity number;
c) assigning the identity number to the reproduction of the joining process; and
d) storing the reproduction of the joining process and the identity number in pairs.

5. Method according to claim 4, wherein the reproduction of the joining process is provided with a raster.

6. Method according to claim 4, wherein joining parameters and/or production data are stored and assigned to the respective identity number.

7. Method according to claim 6, wherein deviation of individual joining parameters from desired values is detected and reset.

8. Method according to claim 4, wherein contact-connection of a wire to pads of a chip are monitored.

9. Method according to claim 4, wherein contact-connection of a wire to contact areas of a chip module, which holds a chip, are monitored.

10. Method according to claim 8, wherein the identity number of the chip is detected.

11. Method according to claim 8, wherein the identity number of the chip is detected.
